(19) United States
(12) Patent Application Publication
(10) Pub. No.: US 2014/0244275 A1
(43) Pub. Date: Aug. 28, 2014

(54) HEALTHCARE MARKETPLACE

(71) Applicant: UNITEDHEALTH GROUP INCORPORATED, Minnetonka, MN (US)

(72) Inventor: Jayant Parthasarathy, Eden Prairie, MN (US)

(73) Assignee: UnitedHealth Group Incorporated, Minnetonka, MN (US)

(21) Appl. No.: 13/775,318

(22) Filed: Feb. 25, 2013

(51) Int. Cl. G06Q 50/22

(52) U.S. Cl. CPC G06Q 50/22; G06Q 30/0283
USPC 705/2

(57) ABSTRACT

Data is obtained from medical service providers. The data includes at least a plurality of available medical service appointments and pricing information. An inquiry for a medical service appointment is received from a user. A number of available medical service appointments are selected based on the inquiry and are then presented to the user. Prices for the available medical service appointments may be included and may be calculated based on current healthcare benefit plan information for the user. In response to a received purchase indication, one of the presented medical service appointments are purchased for the user.

### TECHNICAL FIELD

This disclosure relates generally to buying and selling medical services, and more specifically to facilitating a healthcare marketplace.

### BACKGROUND

The cost of medical (i.e., healthcare) services continues to rise. Even when medical services purchased by users (i.e., healthcare consumers) are covered under one or more healthcare benefit plans, the healthcare benefit plans themselves have costs for users and/or society at large. Often, particularly in the case where users have high-deductible health plans (HDHP), users may be responsible for high out-of-pocket (OOP) costs even when purchased medical services are covered. Users may have difficulty maximizing the value of their spent OOP costs.

One factor that contributes to the increasing cost of medical services is the failure of medical service providers (i.e., physicians and facilities) to collect for provided medical services. Particularly when users are responsible for some portion of provided medical services (i.e., OOP costs), medical service providers may bill the user after the medical services have been provided. The medical service provider simply may not be aware of the portion for which the user is responsible at the time the medical services are provided due to lack of knowledge regarding the user's healthcare benefits plan, co-insurance arrangements, current deductible information, and so on. Because the medical services have often already been provided, collection of the portion for which the user is responsible may be difficult. As a result, medical service providers may spread the loss of such failed collections through prices charged for medical services, thus further increasing the cost of medical services.

### SUMMARY

The present disclosure discloses systems and methods for facilitating a healthcare marketplace. In one or more embodiments, data may be obtained from medical service providers. This data may include at least a plurality of available medical service appointments and pricing information. An inquiry for a medical service appointment may be received from a user. A number of available medical service appointments may be selected based on the inquiry and may then be presented to the user. In response to a received purchase indication, one of the presented medical service appointments may be purchased for the user.

In some implementations, available medical service appointments may be obtained automatically from medical service provider scheduling software. However, in other implementations the available medical service appointments may be manually transmitted by medical service providers and/or medical service provider personnel. In various cases, the inquiry may include a variety of user criteria (such as price constraints, location proximity, participation with particular healthcare benefit plans, and so on) and selection of the available medical service appointments may be based at least in part on matching between available medical service appointments and such criteria.

In various implementations, presenting the selected medical service appointments may include determining prices for appointments and presenting the prices. The prices may be statically or dynamically determined. In some cases, the prices may be dynamically determined based on various factors such as demand for particular types of appointments, demand for particular medical service providers, demand for particular dates and/or times, price constraints set by medical service providers and/or contracts between medical service providers and healthcare benefit plans, comparisons between medical service providers, and so on. In one or more cases, price determination may include obtaining current healthcare benefit plan information for the user and adjusting a base price based on coverage related to the current healthcare benefit plan information and/or discounts related to contracts between the medical service provider and the provider of the respective healthcare benefit plan. In various cases, the prices may be determined by one or more reverse auction arrangements (such as allowing medical service providers to bid in real time based on the user's inquiry and selecting the lowest bid, determining the price based on minimum price information specified by medical service providers, and so on).

In some implementations, verification of the purchased appointment may be performed to ensure that the appointment took place. Related to such verification, a healthcare benefit plan provider may be contacted to analyze a claim submitted related to the purchased appointment and correct coding of such a submitted claim if it is coded incorrectly. Alternatively, such a claim may be submitted on behalf of the medical service provider and/or the user.

In one or more implementations, facilitating the healthcare marketplace may be implemented as a website that users can access utilizing web browsers executing on user computing devices. However, in other implementations, facilitation of the healthcare marketplace may be implemented as a content engine that receives input from and/or provides content to one or more websites operating on other computing devices that users can access utilizing web browsers executing on user computing devices.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is a block diagram illustrating a system for facilitating a healthcare marketplace in accordance with one or more implementations of the present disclosure.

FIG. 2 is a flow chart illustrating a method for facilitating a healthcare marketplace in accordance with one or more implementations of the present disclosure. This method may be performed by the computing device of FIG. 1.

FIG. 3 is a block diagram illustrating software components that may be implemented as part of software executed by a system (such as the computing device of FIG. 1) for facilitating a healthcare marketplace in accordance with one or more implementations of the present disclosure.

FIGS. 4A-4D are diagrams illustrating a user utilizing screens of a website that facilitates a healthcare marketplace in accordance with one or more implementations of the present disclosure. The website may be provided by and/or utilize information provided by the computing device of FIG. 1.

### DETAILED DESCRIPTION

The description that follows includes sample systems, methods, and computer program products that embody various elements of the present disclosure. However, it should be understood that the described disclosure may be practiced in a variety of forms in addition to those described herein.

The present disclosure discloses systems and methods for facilitating a healthcare marketplace. In one or more embodiments, data may be obtained from medical service providers (i.e., physicians and facilities). The data may include at least a plurality of available medical service appointments and pricing information. An inquiry for a medical service appointment may be received from a user. A number of available medical service appointments may be selected based on the inquiry. The selected available medical service appointments may be presented to the user. One of the presented medical service appointments may then be purchased for the user in response to a received purchase indication.

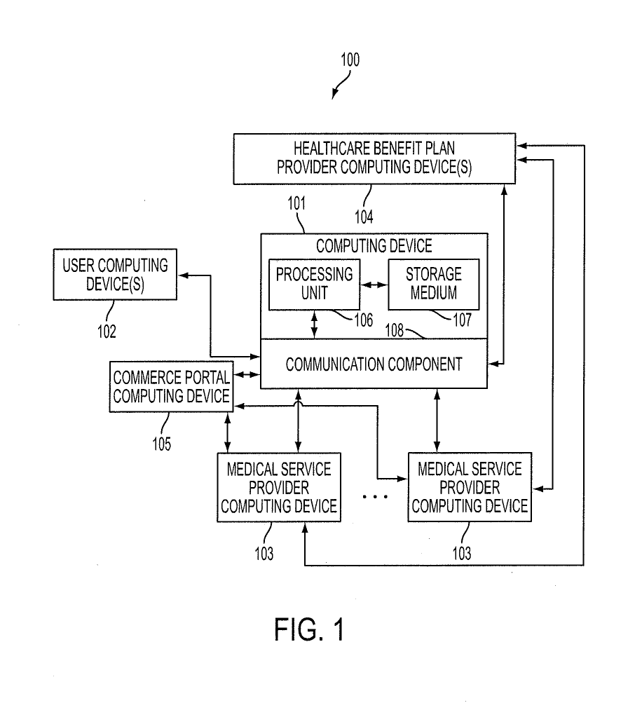

FIG. 1 is a block diagram illustrating a system 100 for facilitating a healthcare marketplace in accordance with one or more implementations of the present disclosure. The system 100 may include a computing device 101 that communicates (which may be via one or more wired and/or wireless networks, such as the Internet and/or other such communication networks) with one or more user computing devices 102 and/or one or more medical service provider computing devices 103.

The computing device 101 may include one or more processing units 106, one or more one or more non-transitory storage media 107 (which may take the form of, but is not limited to, a magnetic storage medium; optical storage medium; magneto-optical storage medium; read only memory; random access memory; erasable programmable memory; flash memory; and so on), and/or one or more communication components 108. The processing unit may execute one or more instructions stored in the non-transitory storage medium to perform one or more computing device functions (such as performing one or more methods for facilitating a healthcare marketplace, communicating with other devices such as one or more user computing devices 102 and/or one or more medical service provider computing devices 103 via the communication component, and/or other such functions).

In some implementations, the system 100 may also include one or more commerce portal computing devices 105 and/or healthcare benefit plan provider computing devices 104. In such implementations, the computing device 101 may be operable to communicate with such commerce portal computing devices 105 and/or healthcare benefit plan provider computing devices 104 via the communication component 108. Moreover, in various implementations, the various illustrated devices may be operable to communicate with each other with or without involvement from the computing device 101.

Although the computing device 101 is illustrated and described as including particular components arranged in a particular configuration, it is understood that this is for the purposes of example. In various implementations, the computing device may include any number of different components (such as processing units, storage devices, hard drives, optical drives, ports, busses, graphics processors, and so on) arranged in any number of different configurations without departing from the scope of the present disclosure. Further, the user computing device(s) 102 and/or the medical service provider computing device(s) 103 (as well as the commerce portal computing device 105, healthcare benefit plan provider computing device(s) 104, and so on) may include similar or different configurations of components.

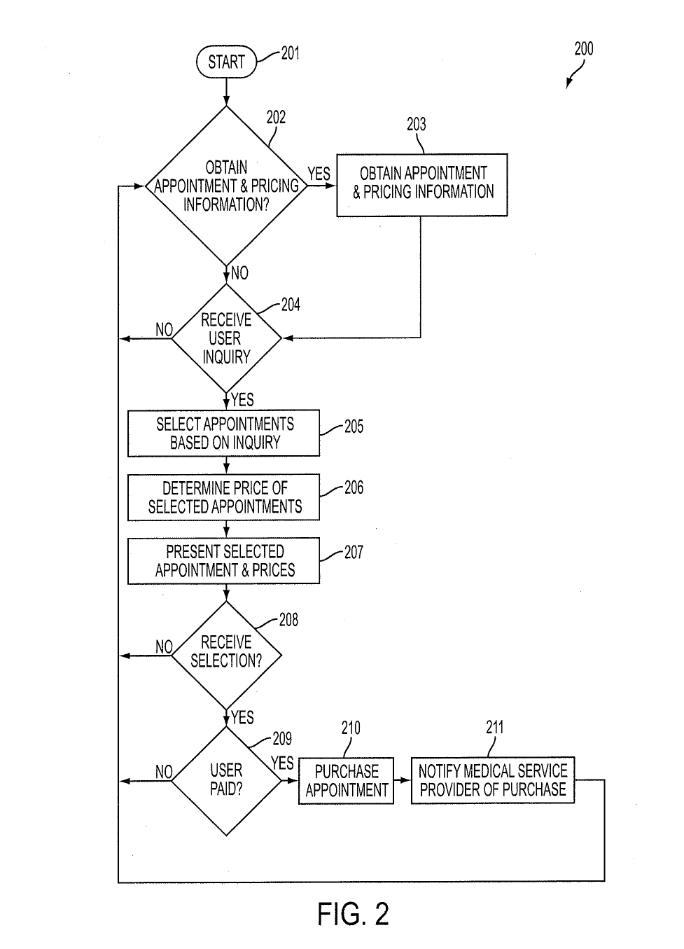

FIG. 2 illustrates a method 200 for facilitating a healthcare marketplace. The method 200 may be performed by the computing device 101 of FIG. 1. The flow begins at block 201 and proceeds to block 202 where the computing device 101 determines whether or not appointment and pricing information is obtained from one or more medical service provider computing devices 103.

The appointment and pricing information may take a variety of forms. For example, the appointment information may include a variety of appointment slots (such as Thursday Jan. 15, 2015 from 8:00 AM to 9:00 AM), appointment types (such as consult, examination, surgical procedure, test, and so on), medical service types (such as general physical, chiropractic alignment, heart bypass surgery, teeth cleaning, x-ray, and/or any other type of medical service), and/or other information related to one or more appointments for medical services (which may be any kind of medical services such as one or more colonoscopies, cholesterol tests, skin mole examinations, filing of one or more cavities, physical therapy sessions, cosmetic surgeries, telephonic and/or other remotely performed consultation, routine medical procedures, imaging procedures, dental procedures, physiotherapy visits, chiropractic visits, elective procedures, and/or any other kind of medical service). Similarly, the pricing information may include a variety of information such as minimum prices the medical provider will accept, discounts contracted to particular healthcare benefit plans, differing pricing information for different appointment times and/or dates, time and/or date exclusions for appointments and/or pricing information, desired prices, and/or other such pricing information. The appointment and/or pricing information may also include information regarding the medical service provider such as one or more names, credentials, locations, ratings, healthcare benefit plan participation, and/or other such information regarding the medical service provider.

The appointment and pricing information may be obtained in a variety of different ways. For example, the computing device 101 may pull available appointments and other information from appointment scheduling software executing on one or more medical service provider computing devices 103 (such as periodically, at one or more scheduled times, when initiated by an operator of the computing device, upon receipt of one or more indications from a medical service provider computing device that information and/or updated information is available, and/or according to any other timing configuration). By way of another example, medical service provider personnel may utilize one or more medical service provider computing devices to transmit the appointment and pricing information to the computing device.

If appointment and pricing information is obtained by the computing device 101 from one or more medical service provider computing devices 103 at block 202, the flow proceeds to block 203 where the appointment and pricing information is obtained (and may be stored in the non-transitory storage medium 107, such as in one or more databases or other data storage structures) before the flow proceeds to block 204. Otherwise, the flow proceeds directly to block 204.

At block 204, the computing device 101 determines whether or not one or more inquiries for a medical service appointment is received from one or more user computing devices 102. If so, the flow proceeds to block 205. Otherwise, the flow returns to block 202 where the computing device determines whether or not appointment and pricing information is obtained from one or more medical service provider computing devices 103.

The inquiry may include a variety of different information specified by the user. For example, the inquiry may include information regarding the type of medical service(s) sought by the user, one or more locations (such as one or more addresses, cities, states, zip codes, and so on) to search within (such as within 5 miles), one or more user identifiers (such as name, identifiers for one or more healthcare benefit plans which cover the user, social security numbers, user addresses, financial information, medical history, personal health record, desired price and/or price ranges such as specified by a maximum and/or a minimum price, desired times and/or dates, and so on) particular healthcare benefit plans within which to search for participating medical service providers, and/or other such information related to the inquiry.

At block 205, after the computing device 101 determines that an inquiry for a medical service appointment is received from one or more user computing devices 102, the computing device selects one or more available appointments based on the inquiry. In some cases, selecting one or more available appointments based on the inquiry may include searching appointment and/or pricing information stored in the non-transitory storage medium 107 and/or other such storage device for available appointments that match one or more criteria included in the inquiry. For example, the inquiry may specify to search for all chiropractic appointments available the week of February 7 with chiropractors within a proximity of five miles of Omaha, Nebr. Based on such information, the computing device may select all available appointments that have times within the week of February 7 and are offered by chiropractors located within five miles of Omaha, Nebr.

In various cases, the number of appointments selected may depend on a variety of different factors. Such factors may include one or more defaults (such as the top twenty results), one or more specifications included in the inquiry (such as only return five results), the number of available appointments matching specifications included in the inquiry, and/or any other such factors.

After the computing device 101 selects the available appointments at block 205, the flow proceeds to block 206 where the computing device determines prices for the selected appointments. The computing device may determine the prices for the appointments in a variety of different ways in a variety of different implementations.

For example, the computing device 101 may determine that the price of an appointment is the price specified in the obtained appointment and pricing information. In such a case, determining may include retrieving the specified price.

By way of a second example, the computing device 101 may obtain current healthcare benefit plan information for the user from one or more healthcare benefit plan provider computing devices 104 and may utilize such information to determine the price for one or more appointments. The computing device may utilize one or more identifiers for one or more healthcare benefit plans which cover the user specified in the inquiry to obtain the current healthcare benefit plan information from the healthcare benefit plan provider computing device(s). In such an example, pricing information specified by the medical service provider for an appointment may be reduced (and/or otherwise modified, adjusted, or altered) by an amount coverable by one or more healthcare benefit plans covering the user (such as whether or not the appointment is a covered event, the percentage of the price covered by the healthcare benefit plan, whether or not the user has exceeded one or more deductibles that the user must pay before coverage is provided, discounts and/or other pricing restrictions contracted between the provider of the healthcare benefit plan and the medical service provider, whether or not the user has exceeded coverage limits, co-insurance arrangements involving the user, co-pays to be paid by the user for events such as the appointment, and so on) to determine the price.

In one hypothetical instance of this example, a user may be covered by a healthcare benefit plan that pays the entirety of the costs of an annual mammogram after the user has exceeded an annual $500 deductible for medical costs. In this hypothetical instance of this example, an available mammogram appointment may include a medical service provider base price of $200. The computing device 100 may obtain current healthcare benefit plan information for the user and determine that the user has spent $400 toward the user's deductible. Therefore, the computing device may determine that $100 of the price of the mammogram appointment will be covered because the other $100 for the appointment will cause the user to reach the user's deductible. As a result, the computing device may calculate that the price of the mammogram appointment is $100 for the user.

By way of a third example, the computing device 101 may determine that the price of an appointment dynamically. In some cases, dynamic price determination may be performed at the time that the inquiry is received. In other cases, the dynamic price determination may be performed prior to receipt of the inquiry and may be updated at one or more other times (such as upon receipt of the inquiry). Regardless when performed, the dynamic price determination may take a variety of factors into account. Such factors may include minimum prices specified by the medical service provider, maximum prices the medical service provider has contracted not to exceed (such as in the case of contractual agreements with a healthcare benefit plan that covers the user), demand for the appointment (which may include demand for the particular medical service provider, demand for one or medical services associated with the appointment, demand for appointments at the same or similar time and/or date, and so on), comparison between medical service providers (such as medical service providers of the same type as the medical service provider corresponding to the appointment who have locations within a certain area, such as within five miles, of the medical service provider corresponding to the appointment), and/or other such factors.

In one hypothetical instance of this example, a particular dentist may set a minimum price for an appointment for installing a crown at $500 and a desired price of $700. The computing device 101 may analyze other dentists practicing within the same city as the particular dentist and determine that the average price for crown installation appointments on the date specified by the particular dentist is $600. As a result, the computing device may determine that the price for the particular dentist's appointment is $600.

By way of a fourth example, the computing device 101 may determine the price for an appointment utilizing one or more reverse auction arrangements. In a first instance of this fourth example, the computing device 101 may contact (such as upon receipt of an inquiry) one or more medical providers (which may be medical service providers corresponding to appointments that have been selected in response to an inquiry) and may offer the medical service providers the opportunity to bid for a particular appointment slot. In such a case, the medical service provider who provides the lowest bid may have that bid utilized as the determined price for a selected appointment with that medical service provider.

In a second instance of this fourth example, the computing device 101 may analyze minimum price information specified in one or more selected appointments. The computing device may pick the selected appointment that has the lowest minimum price. In such a case, the computing device may determine that the price for the picked appointment is an amount between the minimum price specified for that appointment and the next lowest minimum price.

In one hypothetical example of this instance, a group of available appointments for a cardio logical examination may be selected. The lowest minimum price may be specified by a first cardiologist at $300 and the next lowest minimum price may be specified by a second cardiologist at $350. As such, the computing device may pick the first cardiologist's available appointment and determine that the price is $349.

After the computing device 101 determines prices for the selected appointments at block 206, the flow proceeds to block 207 where the computing device presents the selected appointments and prices. Such presentation may include transmission of information regarding the appointments and prices to one or more user computing devices 102 for presentation. Moreover, a variety of information may be presented along with the appointments and prices. Such information may include one or more medical service provider names, one or more medical service provider locations, one or more appointment times, one or more prices (along with information regarding any price adjustments that were made, current healthcare plan coverage details, and so on), distance from a location specified by the user in the inquiry to a medical service provider location, details regarding one or more medical services related to the appointment, one or more ratings of the medical service provider, and/or any other such information regarding the appointment. The presentation may also include one or more options to select one or more of the presented appointments for purchase.

The flow may then proceed to block 208 where the computing device 101 determines whether or not a selection of one or more of the presented appointments has been received from a user computing device 102. If so, the flow proceeds to block 209. Otherwise, the flow may return to block 202 where the computing device determines whether or not appointment and pricing information is obtained from one or more medical service provider computing devices 103 (though in other cases the computing device may instead continue to wait for a selection to be received).

After the computing device 101 determines that a selection of a presented appointment has been received, the flow proceeds to block 209 where the computing device determines whether or not the user has paid for the selected appointment. Determining whether or not the user has paid for the appointment may include processing payment information (such as credit card information, debit card information, check information, checking account information, savings account information, health savings account information, health spending account information, and/or any other financial information) for the user for any amounts not covered by one or more healthcare benefit plans covering the user. Such processing may include transferring the amount (and/or communicating with one or more commerce portal computing devices 105 to transfer the amount) from one or more accounts corresponding to the user's financial information and to one or more accounts associated with the medical service provider corresponding to the appointment (which may be an account maintained by the computing device for the medical service provider, an account directly controlled by the medical service provider, and account such as a treasury account that holds funds for the medical service provider until a healthcare benefit plan claim related to the funds has been adjudicated whereupon the funds are released to the medical service provider, and so on).

After the computing device 101 determines that the user has paid for the selected appointment at block 209, the flow proceeds to block 210 where the computing device purchases the selected appointment for the user. As part of purchasing the appointment for the user, the computing device may provide the user (such as via the user computing device 102) confirmation of the purchase and/or the opportunity to schedule one or more reminders regarding the appointment (such as a text message reminder to be sent periodically up until the date of the appointment, a telephonic reminder to be sent 24 hours prior to the appointment, an email reminder to be sent daily prior to the appointment, and/or other such reminders). If the user schedules such reminders, the computing device 101 and/or another computing device may transmit such reminders at the appropriate times.

Next, the flow proceeds to block 211 where the computing device 101 notifies the respective medical service provider (such as by communicating with the respective medical service provider computing device 103) of the purchase of the appointment. Such notification may include transmitting one or more messages confirming that the appointment has been purchased, editing scheduling software operating on the respective medical service provider computing device, transmitting information for the user to the medical service provider (which may be user medical history and/or personal health record information entered as part of the inquiry, stored in the non-transitory storage medium, or received from one or more healthcare benefit plan provider computing devices 104; one or more forms filled out by the user such as one more personal health record forms, medical service intake forms, and/or other forms; user address, telephone number, and/or other contact information; and/or other user information), and so on.

The flow then returns to block 202 where the computing device determines whether or not appointment and pricing information is obtained from one or more medical service provider computing devices 103.

Although the method 200 is illustrated and described as including particular operations performed in a particular order, it is understood that this is for the purposes of example and is not intended to be limiting. Other arrangements of the same and/or different operations are possible and contemplated without departing from the scope of the present disclosure.

For example, the method 200 is illustrated and described as determining whether or not an inquiry is received after determining whether or not appointment and price information is received. However, in various implementations, these operations may be performed in reverse order, simultaneously and/or in parallel, multiple times, and so on.

Further, in some implementations, one or more operations of the method 200 as illustrated and described may be omitted. For example, in one or more implementations, the computing device 101 may not transmit a notification to the medical service provider subsequent to purchase of an appointment.

Moreover, additional operations to those illustrated and described with respect to method 200 may be performed in various implementations. In some cases, the computing device 101 may analyze whether or not healthcare benefit plan claim information related to the appointment has been coded correctly. Such analysis may include communicating with the respective medical service provider computing device 103 to determine whether or not the purchased appointment occurred and/or communicating with the respective healthcare benefit plan provider computing device 104 to review the related healthcare benefit plan claim information. If the related healthcare benefit plan claim information is not coded correctly, the computing device 101 may correct the coding and/or notify one or more other computing devices to do so. In other cases, the computing device 101 may submit a healthcare benefit plan claim related to the appointment (such as subsequent to communicating with the respective medical service provider computing device to determine that the purchased appointment occurred) on behalf of the user and/or the respective medical service provider. Such submission may include communicating with the respective healthcare benefit plan provider computing device.

In other cases, the computing device 101 may charge one or more transaction fees to the medical service provider associated with the purchased appointment. Such transaction fees may be a flat fee per transaction, a percentage of the purchased appointment cost, and/or any other such transaction fee. Such transaction fee may be the cost that the medical service provider pays in order to sell appointments through the healthcare marketplace.

In various cases, obtaining appointment and pricing information from one or more medical service provider computing devices 103 at block 202 may include determining medical service providers that meet one or more criteria. Such criteria may include whether or not medical service providers have agreed to contractual terms of the healthcare marketplace, whether or not medical service providers meet a minimum quality rating, whether or not medical service providers have a minimum favorable outcome rating for performed medical services, and/or any other such criteria related to medical service providers. In such a case, appointment and pricing information may be obtained from one or more medical service provider computing devices 103 that are associated with medical service providers who meet the one or more criteria.

Additionally, the method 200 and the system 100 are illustrated and described above with respect to purchase of individual appointments. However, in various implementations, appointments may be bundled such that appointments may be offered and purchased as a group of appointments, for an episode of care (i.e., medical services relate to a specific medical problem, condition, or specific illness during a set time period), and/or in other groupings. For example, instead of offering a single chiropractic appointment at a particular date and time for purchase, five chiropractic appointments may be offered in a bundle with a particular date and time defined for the first appointment. By way of another example, instead of offering a single post-operative follow up visit related to an ulcer surgery, an entire episode of care related to post-operative care related to the ulcer surgery may be offered with a particular date and time defined for a first appointment follow up visit.

In some implementations, the healthcare marketplace facilitated by the computing device 101 and described with respect to the method 200 may be implemented as a web site operated by the computing device and accessed by one or more web browsers executing on one or more user computing devices 102. However, in other implementations, such a web site may be operated by a computing device other than the computing device 100 which utilizes the computing device 101 as a content engine and may transmit input received from web browsers executing on one more user computing devices to the computing device 101 and/or receive output from the computing device 101 for transmittal to the web browsers executing on one more user computing devices for presentation to one or more users.

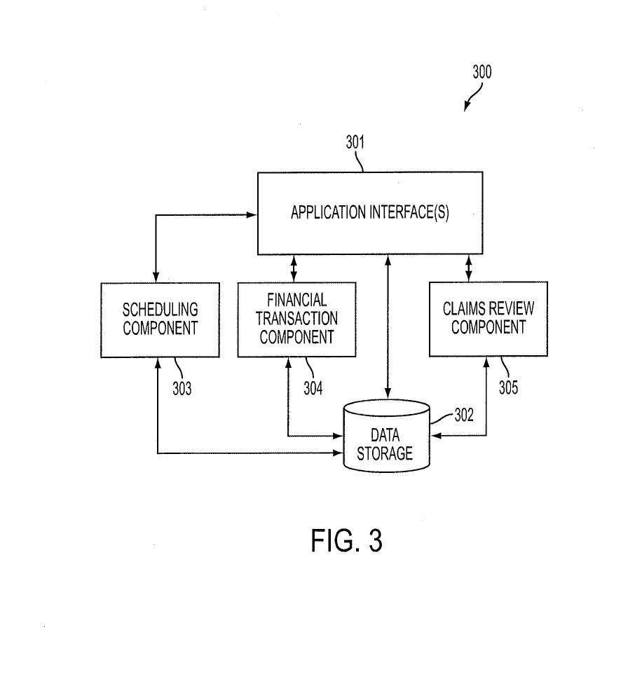

In some cases, a computing device (such as the computing device 101 of FIG. 1) may execute software for facilitating a healthcare marketplace (which may perform the method 200 of FIG. 2 and/or related methods). Such software may include one or more components such as the configuration of software components 300 illustrated in FIG. 3. As illustrated, such software components may include one or more application interfaces 301 for managing input/output for requesting applications, the other components, and so on. Such software components may also include one or more scheduling components 303, one or more financial transaction components 304, one or more claims review components 305, and/or one or more data storage components 302.

The data storage component may store and/or provide (such as for the other components) received user information, purchase information, appointment and pricing information, healthcare plan benefit information, medical service provider information, information regarding one or more contracts and/or other arrangements between one or more medical service providers and/or one or more healthcare benefit plan providers, and/or other such information. The scheduling component may manage receiving and responding to user inquiries for appointments and/or obtaining appointment information from medical service providers. The financial transaction component may enable medical service providers to set pricing information (such as minimum and/or maximum prices, desired prices, and/or other pricing information) and/or may process user financial information and/or other information to purchase selected appointments (such as by communicating with one or more commerce portal computing devices 105). The claims review component may communicate with the medical service provider computing device 103 and/or the healthcare benefit plan provider computing device 104 in order to verify that purchased appointments have occurred, submitted, healthcare benefit plan claims related to appointments have been correctly coded, and/or to submit healthcare benefit plan claims related to appointments on behalf of users and/or medical service providers.

Although FIG. 3 illustrates and describes particular software modules configured in a particular arrangement, it is understood that this is for the purposes of example and is not intended to be limiting. In other implementations, the software may be implemented using different configurations of the same and/or different modules without departing from the scope of the present disclosure. For example, in some implementations, the scheduling component 303 and the financial transaction component 304 may be implemented as a single, unified component.

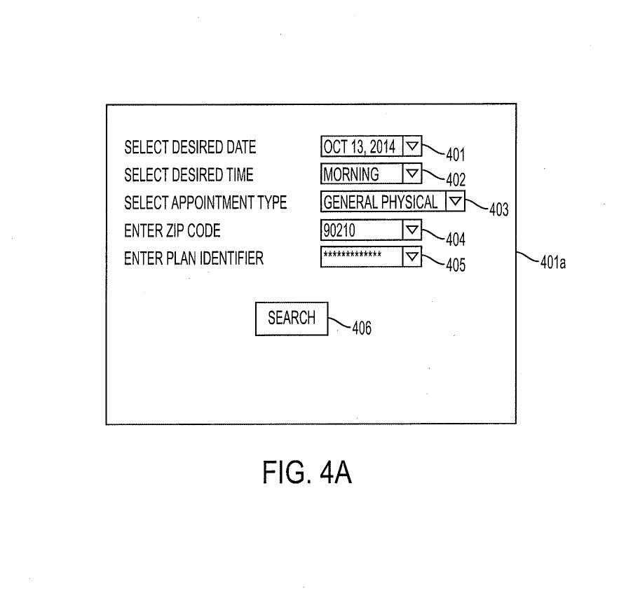

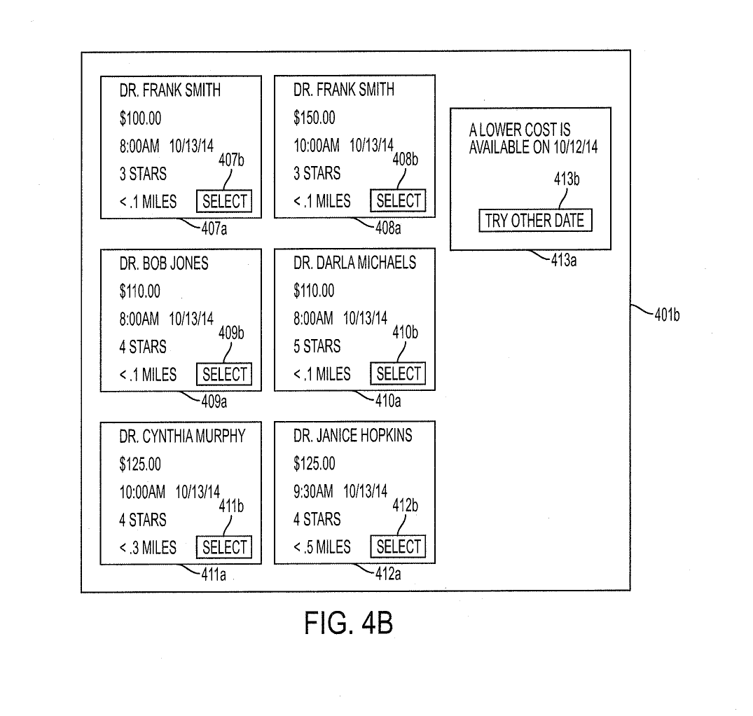

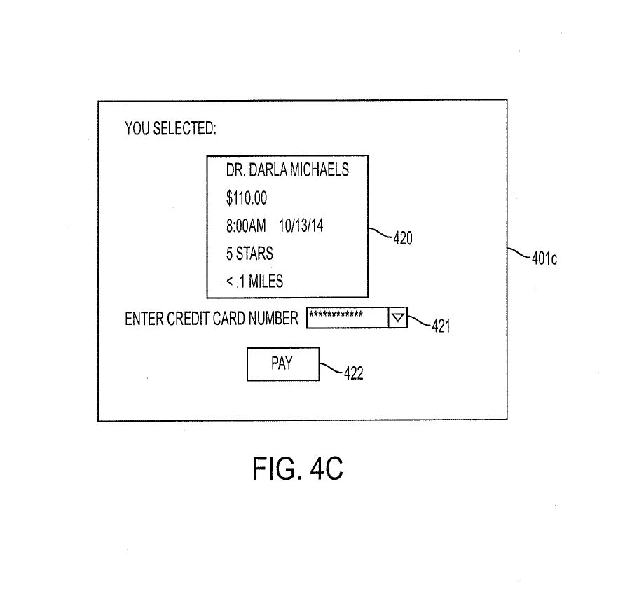

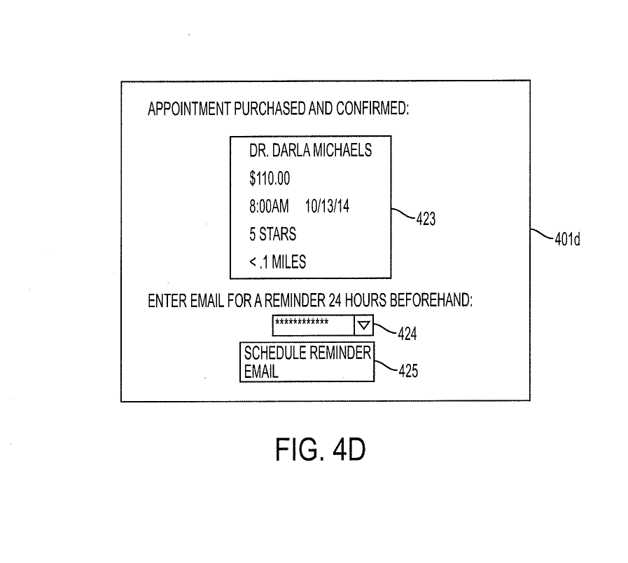

FIGS. 4A-4D illustrate example screens 401a-401d of an example website that facilitates a healthcare marketplace in accordance with one or more implementations of the present disclosure. The website may be provided by and/or utilize information provided by the computing device 101 of FIG. 1 which may implement a method such as the method 200 of FIG. 2.

As illustrated in FIG. 4A, the screen 401a prompts a user to enter a desired date for an appointment (box 401), a desired time for an appointment (box 402), an appointment type (box 403), a user zip code (box 404), and a plan identifier (box 405). The screen 401a also includes a “Search” button 406 for the user to click to initiate an appointment inquiry based on the information entered in boxes 401-405.

In this example, the website is operated by a particular healthcare benefit plan provider. As such, the box 405 only prompts for the user's healthcare benefit plan identification number as opposed to requiring identification of the user's healthcare benefit plan provider. As such, this example may only service users covered by the particular healthcare benefit plan provider and may only obtain appointments for medical service providers that have a contractual relationship with the particular healthcare benefit plan provider.

As further illustrated in FIG. 4A, the user has entered a desired date of Oct. 13, 2014, a desired time of “Morning,” an appointment type of “General Physical,” a zip code of “90210,” and a plan identifier that is displayed as a series of asterisks for security purposes. FIG. 4B illustrates the updated screen 401b after the user clicks the button 406.

As illustrated in FIG. 4B, a number of available appointments 407a-412a are displayed along with respective buttons 407b-412b that the user may click to select the respective displayed appointment. As also illustrated, the screen 401b also includes a message box 413a indicating that an appointment with a price lower than those illustrated is available on the day prior to the user's selected date and includes a button 413b that the user may click to view appointments for the other date.

As further illustrated in FIG. 4B, the available appointment 407a is for a general physical with Dr. Frank Smith, who has a three star rating and is located less than 0.1 miles from the 90210 zip code, for a cost of $100 at 8:00 AM on Oct. 13, 2014. The available appointment 408a is for a general physical with Dr. Frank Smith, who has a three star rating and is located less than 0.1 miles from the 90210 zip code, for a cost of $150 at 10:00 AM on Oct. 13, 2014. The available appointment 409a is for a general physical with Dr. Bob Jones, who has a four star rating and is located less than 0.1 miles from the 90210 zip code, for a cost of $110 at 8:00 AM on Oct. 13, 2014. The available appointment 410a is for a general physical with Dr. Darla Michaels, who has a five star rating and is located less than 0.1 miles from the 90210 zip code, for a cost of $110 at 8:00 AM on Oct. 13, 2014. The available appointment 411a is for a general physical with Dr. Cynthia Murphy, who has a four star rating and is located less than 0.3 miles from the 90210 zip code, for a cost of $125 at 10:00 AM on Oct. 13, 2014. The available appointment 412a is for a general physical with Dr. Janice Hopkins, who has a four star rating and is located less than 0.5 miles from the 90210 zip code, for a cost of $125 at 9:30 AM on Oct. 13, 2014.

It should be noted that the available appointments 408a and 409a are both for Dr. Frank Smith, though the available appointments are for different costs at different times. In this example, this is a result of Dr. Frank Smith setting a higher cost for his midmorning appointments (for which he experiences a higher demand) than for his early morning appointments.

FIG. 4C illustrates the screen 401c after the user clicked button 410b to select the appointment 410a with Dr. Darla Michaels. As illustrated, the screen 401c presents a box 420 that displays the user's selection. As also illustrated, the screen 401c also includes a box 421 for the user to enter credit card information and a button 422 for the user to click when the credit card number has been entered and the user wishes to purchase the appointment.

FIG. 4D illustrates the screen 401d after the user clicked button 422 to purchase the appointment with Dr. Darla Michaels. As illustrated, the screen 401d presents a box 423 that displays information regarding the appointment the user just purchased. As also illustrated, the screen 401d provides a box 424 for the user to enter an email address to which a 24 hour reminder regarding the purchased reminder will be sent and a button 425 for the user to schedule the reminder after entering the email address.

Although FIGS. 4A-4D illustrate example screens of a healthcare marketplace website that include particular elements arranged in a particular order, it is understood that such screens are provided for the purpose of example and are not intended to be limiting. In other implementations, other screens of possibly differing numbers with different combinations of the same and/or similar elements may be presented in similar or differing orders without departing from the scope of the present disclosure.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

We claim:

1. A method for facilitating a healthcare marketplace, the method comprising:
obtaining data from a plurality of medical service providers, utilizing at least one processing unit, the data including a plurality of available medical service appointments, each of the plurality of available medical service appointments corresponding to at least one of the plurality of medical service providers and including pricing information;
receiving at least one inquiry for at least one medical service appointment from at least one user utilizing the at least one processing unit;
presenting at least one medical service appointment of the plurality of available medical service appointments to the at least one user utilizing the at least one processing unit, the presented at least one of the plurality of available medical service appointments selected based at least on the at least one inquiry; and
purchasing the presented at least one medical service appointment, utilizing the at least one processing unit, for the at least one user based at least on at least one purchase indication received from the at least one user.

2. The method of claim 1, further comprising:
obtaining current healthcare benefit plan information for the at least one user from at least one healthcare benefit plan provider.

3. The method of claim 1, wherein said operation of presenting at least one medical service appointment of the plurality of available medical service appointments to the at least one user utilizing the at least one processing unit further comprises:
determining at least one appointment price for the at least one medical service appointment; and
presenting the at least one appointment price.

4. The method of claim 3, wherein said operation of determining at least one appointment price for the at least one medical service appointment further comprises:
obtaining current healthcare benefit plan information for the at least one user from at least one healthcare benefit plan provider; and
adjusting the pricing information for the at least one medical service appointment based at least on the obtained current healthcare benefit plan information for the at least one user.

5. The method of claim 4, wherein said operation of adjusting the pricing information for the at least one medical service appointment based at least on the obtained current healthcare benefit plan information for the at least one user further comprises:
applying at least one discount that the respective medical service provider of the plurality of medical service providers corresponding to the at least one medical service appointment has agreed to provide to members of a healthcare benefit plan associated with the obtained current healthcare benefit plan information for the at least one user.

6. The method of claim 3, wherein said operation of determining at least one appointment price for the at least one medical service appointment further comprises:
dynamically determining the at least one appointment price upon receipt of the at least one inquiry.

7. The method of claim 6, wherein said operation of dynamically determining the at least one appointment price upon receipt of the at least one inquiry is based on at least one of:
a minimum price specified by the respective medical service provider of the plurality of medical service providers;
a maximum price the respective medical service provider of the plurality of medical service providers has contracted not to exceed;
demand for:
the respective medical service provider of the plurality of medical service providers,
at least one medical service associated with the at least one medical service appointment,
at least one date associated with the at least one medical service appointment, or
at least one time associated with the at least one medical service appointment; or
comparison of the respective medical service provider of the plurality of medical service providers to at least one other medical service provider in a same area as the respective medical service provider.

8. The method of claim 6, wherein said operation of dynamically determining the at least one appointment price upon receipt of the at least one inquiry further comprises:
receiving bids from a group of medical service providers of the plurality of medical service providers submitted based on the at least one inquiry; and
selecting the lowest bid.

9. The method of claim 6, wherein said operation of dynamically determining the at least one appointment price upon receipt of the at least one inquiry further comprises:
comparing minimum price information specified by a group of medical service providers of the plurality of medical service providers;
selecting at least one medical service provider of the group of medical service providers that has lowest minimum price information; and
setting the at least one appointment price as lower than the minimum price information of the medical service provider of the group of medical service providers that has the second lowest minimum price information.

10. The method of claim 1, wherein said operation of purchasing the presented at least one medical service appointment further comprises:
receiving payment information from the at least one user; and
processing the payment information to transfer funds associated with a price of the presented at least one medical service appointment.

11. The method of claim 10, wherein the price of the presented at least one medical service appointment is calculated by subtracting a base price determined from the pricing information provided by the respective medical service provider of the plurality of medical service providers for the presented at least one medical service appointment from coverage for the presented at least one medical service appointment specified in current healthcare benefit plan information for the at least one user.

12. The method of claim 10, further comprising:
transferring the transferred funds to the at least one of the plurality of medical service providers corresponding to the at least one medical service appointment.

13. The method of claim 10, wherein said operation of processing the payment information to transfer funds associated with a price of the presented at least one medical service appointment further comprises:
transferring the funds to an account associated with the at least one of the plurality of medical service providers corresponding to the presented at least one medical service appointment wherein the funds are released from the account to the at least one of the plurality of medical service providers corresponding to the presented at least one medical service appointment subsequent to adjudication of at least one healthcare benefit plan claim corresponding to the presented at least one medical service appointment.

14. The method of claim 1, wherein the purchase of the presented at least one medical service appointment involves coverage for the presented at least one medical service appointment specified in current healthcare benefit plan information for the at least one user, the method further comprising:
determining that a medical service corresponding to the presented at least one medical service appointment have been performed;
analyzing at least one healthcare benefit plan claim related to the performed medical service to determine if the at least one healthcare benefit plan claim was correctly coded; and
if the at least one healthcare benefit plan claim was incorrectly coded, correcting the coding for the at least one healthcare benefit plan claim.

15. The method of claim 1, wherein the purchase of the presented at least one medical service appointment involves coverage for the presented at least one medical service appointment specified in current healthcare benefit plan information for the at least one user, the method further comprising:
determining that a medical service corresponding to the presented at least one medical service appointment have been performed;
submitting at least one healthcare benefit plan claim related to the performed medical service to at least one provider corresponding to the current healthcare benefit plan information for the at least one user on behalf of the at least one of the plurality of medical service providers corresponding to the presented at least one medical service appointment.

16. The method of claim 1, further comprising:
transmitting at least one notification regarding the purchase of the presented at least one medical service appointment to the at least one of the plurality of medical service providers corresponding to the presented at least one medical service appointment.

17. The method of claim 16, wherein the at least one notification includes personal health record information for the at least one user.

18. The method of claim 1, wherein the presented at least one medical service appointment comprises a bundle of medical services that includes the at least one medical service appointment.

19. The method of claim 18, wherein the bundle of medical services comprises medical services related to at least one episode of care associated with the at least one medical service appointment.

20. The method of claim 1, wherein said operation of obtaining data from a plurality of medical service providers further comprises:
obtaining schedule data from at least one scheduling program of at least one of the plurality of medical service providers.

21. The method of claim 1, wherein:
said operation of receiving at least one inquiry for at least one medical service appointment from at least one user utilizing the at least one processing unit further comprises receiving the at least one inquiry via at least one computing device that operates at least one website utilized by the at least one user; and
said operation of presenting at least one medical service appointment of the plurality of available medical service appointments to the at least one user utilizing the at least one processing unit further comprises presenting the at least one medical service appointment to the at least one computing device that operates the at least one website utilized by the at least one user.

22. The method of claim 1, wherein at least one of:
the at least one inquiry includes location information for the at least one user and the presented at least one of the plurality of available medical service appointments is selected based at least on a proximity between the location information for the at least one user and at least one location of the respective medical service provider of the plurality of medical service providers associated with the presented at least one of the plurality of available medical service appointments;
the at least one inquiry includes identification of at least one healthcare benefit plan for the at least one user and the presented at least one of the plurality of available medical service appointments is selected based at least on acceptance of the at least one healthcare benefit plan by the respective medical service provider of the plurality of medical service providers associated with the presented at least one of the plurality of available medical service appointments; or
the at least one inquiry includes a type of appointment and the presented at least one of the plurality of available medical service appointments is selected based at least on the type of appointment associated with the presented at least one of the plurality of available medical service appointments.

23. The method of claim 1, further comprising:
charging at least one transaction fee to the respective medical service provider of the plurality of medical service providers that corresponds to the purchased at least one medical service appointment.

24. The method of claim 1, wherein said operation of obtaining data from a plurality of medical service providers further comprises:
determining if at least one medical service provider meets at least one criteria; and
including the at least one medical service provider in the plurality of medical service providers if the at least one medical service provider is determined to meet the at least one criteria.

25. A system for facilitating a healthcare marketplace, comprising:
at least one communication component;
at least one processing unit; and
at least one non-transitory machine readable medium storing instructions executable by the at least one processing unit to
obtain data from a plurality of medical service providers utilizing the at least one communication component, the data including a plurality of available medical service appointments, each of the plurality of available medical service appointments corresponding to at least one of the plurality of medical service providers and including pricing information; and
receive at least one inquiry for at least one medical service appointment from at least one user utilizing the at least one communication component;
present at least one medical service appointment of the plurality of available medical service appointments to the at least one user utilizing the at least one communication component, the presented at least one of the plurality of available medical service appointments selected based at least on the at least one inquiry;
purchase the presented at least one medical service appointment for the at least one user based at least on at least one purchase indication received from the at least one user utilizing the at least one communication component.

26. A method for facilitating a healthcare marketplace, the method comprising:
obtaining data from a plurality of medical service providers, utilizing at least one processing unit, the data including a plurality of available medical service appointments, each of the plurality of available medical service appointments corresponding to at least one of the plurality of medical service providers and including pricing information;
receiving at least one inquiry for at least one medical service appointment from at least one user utilizing the at least one processing unit;
presenting at least one medical service appointment of the plurality of available medical service appointments to the at least one user utilizing the at least one processing unit, the presented at least one of the plurality of available medical service appointments selected based at least on the at least one inquiry, comprising:
determining at least one appointment price for the at least one medical service appointment by obtaining current healthcare benefit plan information for the at least one user from at least one healthcare benefit plan provider and adjusting the pricing information for the at least one medical service appointment based at least on the obtained current healthcare benefit plan information for the at least one user; and
presenting the at least one appointment price; and
purchasing the presented at least one medical service appointment, utilizing the at least one processing unit, for the at least one user based at least on at least one purchase indication received from the at least one user.
